(19) United States
(12) Patent Application Publication
(10) Pub. No.: US 2017/0005395 A1
(43) Pub. Date: Jan. 5, 2017

(54) ANTENNA DEVICE

(71) Applicant: TDK Corporation, TOKYO (JP)

(72) Inventors: Toshifumi KOMACHI, TOKYO (JP); Hirohumi ASOU, TOKYO (JP); Toshio TOMONARI, TOKYO (JP)

(73) Assignee: TDK Corporation, TOKYO (JP)

(21) Appl. No.: 15/190,525

(22) Filed: Jun. 23, 2016

(30) Foreign Application Priority Data
Jun. 30, 2015 (JP) 2015-130777
Jul. 8, 2015 (JP) 2015-136738

(51) Int. Cl. H01Q 1/24; H01Q 1/50; H01Q 1/22; H04B 5/00; H01Q 1/38; H01Q 9/28

(52) U.S. Cl. CPC H01Q 1/243; H01Q 1/38; H01Q 9/28; H01Q 1/2291; H04B 5/0031; H01Q 1/50

(57) ABSTRACT

Disclosed herein is an antenna device that includes a planar coil antenna, a high-frequency antenna that overlaps a part of the planar coil antenna in a plan view, and a magnetic sheet that overlaps another part of the planar coil antenna without overlapping the high-frequency antenna in a plan view.

### BACKGROUND OF THE INVENTION

Field of the Invention

The present invention relates to an antenna device and, more particularly, to an antenna device suitable for NFC (Near Field Communication).

Description of Related Art

In recent years, mobile wireless devices typified by smartphones have various communication functions such as wireless LAN, Bluetooth, GPS, and NFC, as well as a telephone and data communication functions.

Such a mobile wireless device is provided with a metal shield in order to protect a built-in circuit from external noise and prevent unnecessary radiation of noise generated inside the device. In particular, recently, in view of thinning, light-weighting, durability against impact at the time of falling, and designability, a housing itself of the mobile wireless device is often made of a metal instead of a resin and serves also as the metal shield. However, the metal shield blocks radio waves in general, so that when an antenna needs to be provided, it needs to be disposed at a position not covered with the metal shield. Thus, when the metal shield covers a wide area, it is difficult to dispose the antenna.

For example, to solve the above problem, an antenna device described in Japanese Patent No. 4,941,600 is an NFC antenna suitable for an RFID system and includes a loop or spiral coil conductor, a conductor layer having a conductor opening and a slit part continuous with the conductor opening, and a magnetic sheet disposed at a position further than the coil conductor from the conductor layer, wherein an opening of the coil conductor overlaps the conductor opening in a plan view. In this antenna device, a current flows in the metal layer so as to block a magnetic field generated due to flowing of the current in the coil conductor. Then, the current flowing around an opening portion of the metal layer passes around a slit, with the result that the current also flows around the metal layer by an edge effect. Thus, a magnetic field is generated also from the metal layer, and the metal layer enlarges a magnetic flux loop, whereby a communication distance between the antenna device and a counterpart antenna can be extended.

Further, an antenna device described in Japanese Patent No. 5,234,216 includes a coil conductor and a planar conductor. A coil opening through which a winding axis of the coil conductor passes is disposed outside an outer periphery of the planar conductor so as to be opposite to the planar conductor, and the coil conductor and the planar conductor overlap, at least partially, each other in a plan view from the winding axis direction. Therefore, it is possible to realize an antenna device having a small occupied area while ensuring a predetermined communication distance.

In a case where the housing itself of the mobile wireless device serves also as the metal shield as described above, it is necessary to dispose an antenna at a position not covered with the metal shield, and when the metal shield covers a wide area, it is difficult to dispose the antenna. In particular, when both a planar coil antenna for NFC and a high-frequency antenna used for UHF band wireless communication are mounted, it is very difficult to achieve efficient layout while ensuring desired antenna characteristics.

### SUMMARY

An object of the present invention is therefore to provide an antenna device allowing a planar coil antenna to be efficiently laid out in a limited space inside a housing of a mobile wireless device while ensuring satisfactory antenna characteristics.

To solve the above problem, an antenna device according to a first aspect of the present invention includes a planar coil antenna, a high-frequency antenna that overlaps a part of the planar coil antenna in a plan view, and a magnetic sheet that overlaps another part of the planar coil antenna in a plan view and does not overlap the high-frequency antenna in a plan view.

According to the above invention, it is possible to efficiently lay out both the planar coil antenna and high-frequency antenna within a limited space inside a housing of a mobile wireless device while ensuring desired antenna characteristics of the planar coil antenna and high-frequency antenna. Further, it is possible to ensure desired antenna characteristics of the high-frequency antenna by suppressing influence that the magnetic sheet has on the high-frequency antenna while ensuring a magnetic path of magnetic flux that crosses the planar coil antenna.

In the above invention, the high-frequency antenna preferably does not cover a coil axis of the planar coil antenna. Further, an area of a region where the high-frequency antenna overlaps an inner diameter portion of the planar coil antenna is preferably less than 62.5% of a total area of the inner diameter portion of the planar coil antenna, more preferably, equal to or less than 50%, and still more preferably, equal to or more than 12.5% and equal to or less than 50%. With this configuration, it is possible to prevent characteristics of the planar coil antenna from being deteriorated due to influence of the high-frequency antenna.

In the above invention, it is preferable that the planar coil antenna has a loop-shaped or spiral-shaped coil pattern, and that the high-frequency antenna covers a part of the coil pattern and a part of an inner diameter portion surrounded by the coil pattern. With this configuration, it is possible to efficiently lay out the planar coil antenna within a limited space inside a housing widely covered with the high-frequency antenna while ensuring desired antenna characteristics of the planar coil antenna.

In the above invention, it is preferable that the planar coil antenna is disposed parallel to a first direction and a second direction perpendicular to the first direction, that the planar conductor extends from one end portion to the other end portion of the planar coil antenna in the first direction and covers the one end portion of the planar coil antenna, that an edge of the planar conductor extends in the second direction to pass across the coil pattern, and that the other end portion of the planar coil antenna in the first direction is not covered with the planar conductor. With this configuration, it is possible to efficiently lay out the planar coil antenna within a limited space inside a housing widely covered with the planar conductor while ensuring satisfactory antenna characteristics of the planar coil antenna.

In the above invention, it is preferable that the planar coil antenna, high-frequency antenna, and magnetic sheet are housed inside a housing of a mobile wireless device, and that a part of the housing that covers at least the planar coil antenna and high-frequency antenna is made of resin. With this configuration, the housing does not have influence on characteristics of the planar coil antenna and high-frequency antenna. Thus, it is possible to efficiently lay out both the planar coil antenna and high-frequency antenna within a limited space inside the housing while ensuring desired antenna characteristics of the planar coil antenna and high-frequency antenna.

In the above invention, it is preferable that the planar coil antenna and magnetic sheet are housed inside the housing of the mobile wireless device, and that the high-frequency antenna constitutes a part of the housing. With this configuration, there is no need to ensure a space for mounting of the high-frequency antenna inside the housing, so that it is possible to enhance a degree of freedom of the layout of the planar coil antenna. Further, there is no member that influences electromagnetic waves to be radiated from the high-frequency antenna outside the high-frequency antenna, so that radiation characteristics of the high-frequency antenna can be improved.

An antenna device according to a second aspect of the present invention includes a planar coil antenna having a loop-shaped or spiral-shaped coil pattern and a planar conductor disposed on one main surface side of the planar coil antenna so as to overlap a part of the coil pattern and an inner diameter portion surrounded by the coil pattern in a plan view. An area of a region where the planar conductor overlaps the inner diameter portion is less than 62.5% of a total area of the inner diameter portion.

According to the above invention, it is possible to efficiently lay out the planar coil antenna a within a limited space inside a housing of a mobile wireless device while ensuring satisfactory antenna characteristics of the planar coil antenna.

In the above invention, the area of the region where the planar conductor overlaps the inner diameter portion of the planar coil antenna is preferably equal to or less than 50% of the total area of the inner diameter portion and, more preferably, equal to or more than 12.5% and equal to or less than 50%. With this configuration, it is possible to increase a communication distance of the planar coil antenna by reliably suppressing influence that the planar conductor has on the planar coil antenna, thereby achieving both ensuring of antenna characteristics and space saving.

In the above invention, the planar conductor preferably does not cover a coil axis of the planar coil antenna. In this case, the area of the region where the planar conductor overlaps the inner diameter portion of the planar coil antenna is preferably less than 50% of the total area of the inner diameter portion of the planar coil antenna and, more preferably, equal to or less than 37.5%. With this configuration, it is possible to reliably suppress characteristics of the planar coil antenna from being deteriorated due to influence of the planar conductor.

In the above invention, it is preferable that the planar coil antenna is disposed parallel to a first direction and a second direction perpendicular to the first direction, that the planar conductor extends from one end portion to the other end portion of the planar coil antenna in the first direction and covers the one end portion of the planar coil antenna, that an edge of the planar conductor extends in the second direction to pass across the coil pattern, and that the other end portion of the planar coil antenna in the first direction is not covered with the planar conductor. With this configuration, it is possible to efficiently lay out the planar coil antenna within a limited space inside a housing widely covered with the planar conductor while ensuring satisfactory antenna characteristics of the planar coil antenna.

In the above invention, it is preferable that the planar coil antenna is housed inside a housing of a mobile wireless device, and that the planar conductor constitutes a part of the housing. When the housing of the mobile wireless device is constituted of the planar conductor, durability and designability of the mobile wireless device can be improved; however, a shielding effect of the planar conductor may disable the communication function of the antenna device. According to the present invention, such a problem can be solved, and it is possible to realize wireless communication using the planar coil antenna by suppressing influence of the planar conductor.

In the above invention, the planar conductor is preferably a high-frequency antenna. When both the planar coil antenna and high-frequency antenna are mounted in the housing of the mobile wireless device, layout thereof becomes a problem. However, according to the present invention, it is possible to efficiently lay out both the planar coil antenna and high-frequency antenna within a limited space inside the housing of the mobile wireless device while ensuring satisfactory antenna characteristics of the planar coil antenna and high-frequency antenna.

According to the present invention, there can be provided an antenna device allowing the planar coil antenna and high-frequency antenna to be efficiently laid out in a limited space inside the housing of the mobile wireless device while ensuring satisfactory antenna characteristics of the planar coil antenna and high-frequency antenna.

### BRIEF DESCRIPTION OF THE DRAWINGS

The above features and advantages of the present invention will be more apparent from the following description of certain preferred embodiments taken in conjunction with the accompanying drawings, in which:

FIG. 1 is a schematic perspective view illustrating a configuration of a mobile wireless device including an antenna device according to a first embodiment of the present invention;

FIGS. 2A and 2B are plan views each transparently illustrating a configuration of the antenna device shown in FIG. 1;

FIG. 3 is a cross-sectional view of the antenna device taken along a line A-A of FIGS. 2A and 2B;

FIG. 4 is a graph illustrating a relationship between a covering area of a planar conductor and a communication distance of the planar coil antenna;

FIGS. 5A and 5B are plan views each transparently illustrating a configuration of an antenna device according to a second embodiment of the present invention;

FIG. 6 is a cross-sectional view of the antenna device taken along a line A-A of FIGS. 5A and 5B;

FIG. 7 is a cross-sectional view of an antenna device according to a third embodiment of the present invention;

FIG. 8 is a cross-sectional view of an antenna device according to a fourth embodiment of the present invention;

FIG. 9 is a cross-sectional view of an antenna device according to a fifth embodiment of the present invention;

FIG. 10 is a cross-sectional view of an antenna device according to a sixth embodiment of the present invention;

FIG. 11 is a cross-sectional view of an antenna device according to a seventh embodiment of the present invention;

FIG. 12 is a plan view illustrating a configuration of an antenna device according to an eighth embodiment of the present invention;

FIG. 13 is a perspective view illustrating a configuration of a mobile wireless device including an antenna device according to a ninth embodiment of the present invention;

FIGS. 14A and 14B are plan views each transparently illustrating a configuration of the antenna device shown in FIG. 13

FIG. 15 is a cross-sectional view of the antenna device taken along a line A-A of FIGS. 14A and 14B;

FIG. 16 is a cross-sectional view of an antenna device according to a tenth embodiment of the present invention;

FIGS. 17A and 17B are plan views each transparently illustrating a configuration of the antenna device according to an eleventh embodiment of the present invention;

FIG. 18 is a cross-sectional view of the antenna device taken along a line A-A of FIGS. 17A and 17B; and

FIG. 19 is a plan view of illustrating a configuration of an antenna device according to a twelfth embodiment of the present invention.

### DETAILED DESCRIPTION OF THE EMBODIMENTS

Preferred embodiments of the present invention will be explained below in detail with reference to the accompanying drawings.

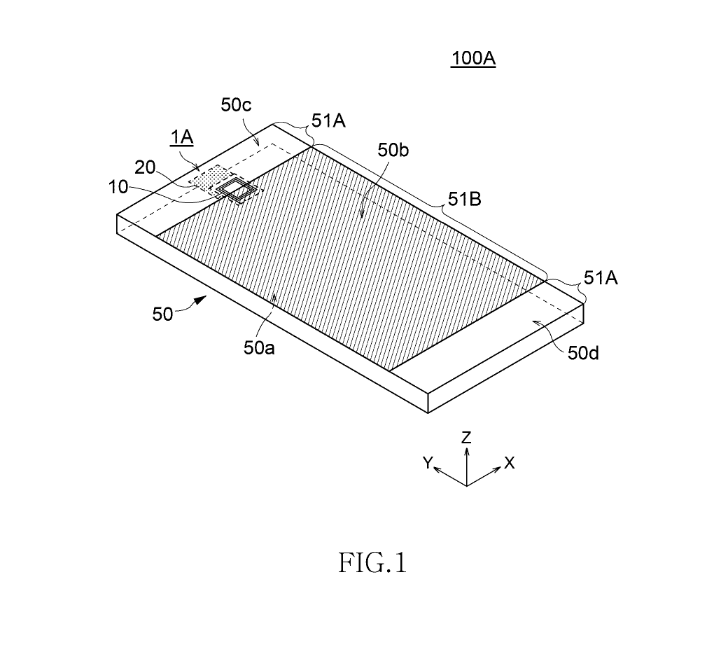

FIG. 1 is a schematic perspective view illustrating a configuration of a mobile wireless device 100A including an antenna device according to a first embodiment of the present invention.

As illustrated in FIG. 1, a mobile wireless device 100A according to the present embodiment is, e.g., a smartphone and has a very thin housing 50. In FIG. 1, a back surface 50b of the housing 50 faces upward, and a front surface 50a of the housing 50 on which a display is mainly disposed faces downward. The housing 50 is made of a combination of a resin and a metal, and a metal cover layer 51B is formed in a wide area thereof including a center portion of the back surface 50b. Further, a resin cover layer 51A is formed on one end portion (upper end portion 50c) and the other end portion (lower end portion 50d) of the back surface 50b of the housing 50 in a longitudinal direction (Y-direction). The resin cover layer 51A is a non-shielded region where the metal cover layer 51B is not formed. The metal cover layer 51B is provided for improving mechanical strength, electromagnetic shielding characteristics, and designability of the housing.

The mobile wireless device 100A incorporates an antenna device 1A. The antenna device 1A is disposed in the upper end portion 50c of the housing 50. The antenna device 1A according to the present embodiment includes a planar coil antenna 10 used for HF-band wireless communication and a high-frequency antenna 20 used for UHF-band wireless communication. The planar coil antenna 10 is, e.g., an NFC antenna and has a resonant frequency of, 13.56 MHz. These antenna elements are disposed near the upper end portion 50c of the housing 50 not covered with the metal cover layer 51B and can thus perform wireless communication.

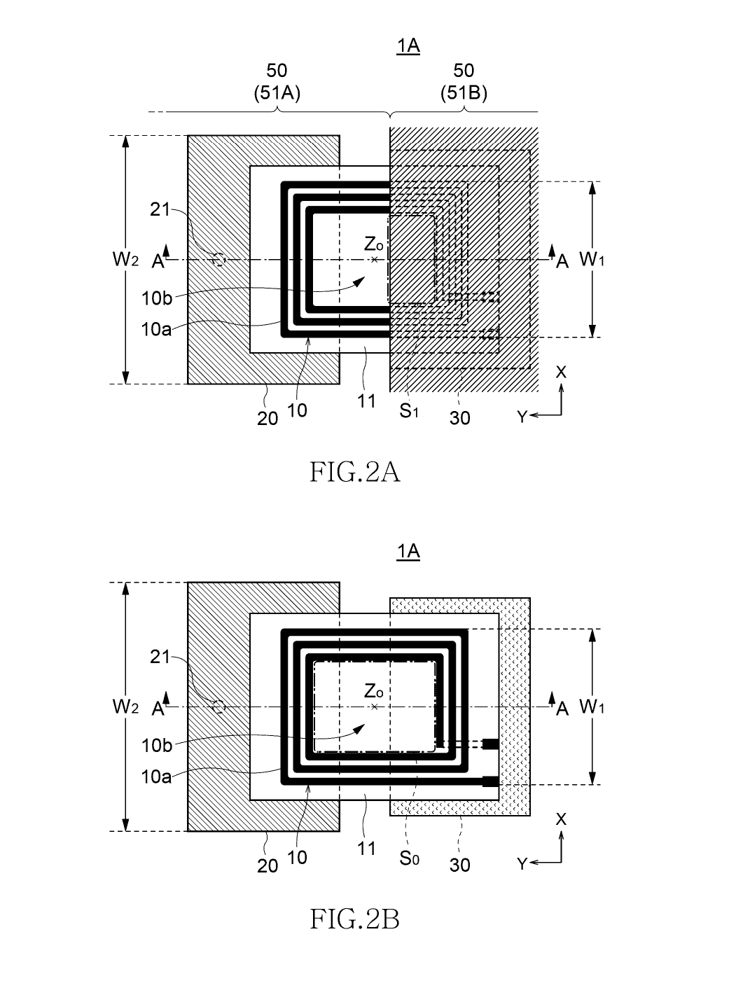

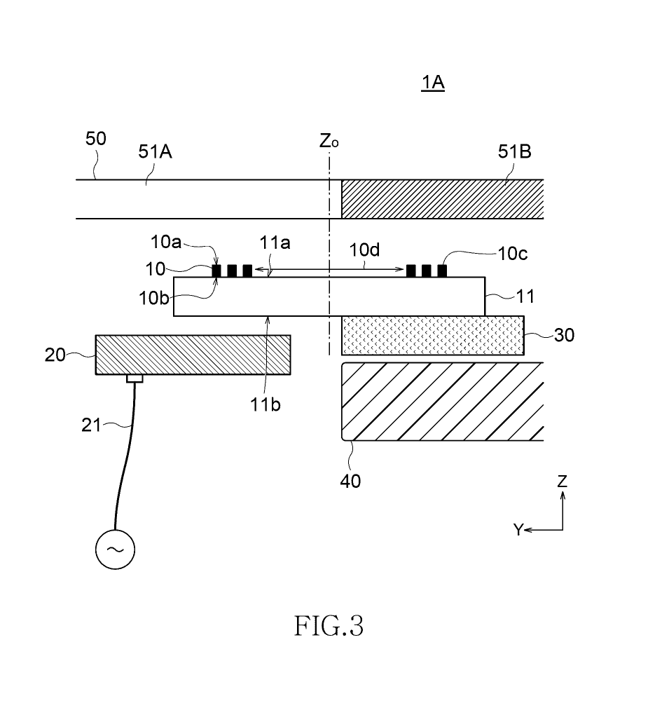

FIGS. 2A and 2B are plan views each transparently illustrating a configuration of the antenna device 1A illustrated in FIG. 1. FIG. 2A illustrates a state where the housing 50 (especially, metal cover layer 51B) is present, and FIG. 2B illustrates a state where the housing 50 is omitted. FIG. 3 is a cross-sectional view of the antenna device 1A taken along a line A-A of FIGS. 2A and 2B.

As illustrated in FIGS. 2A, 2B, and FIG. 3, the antenna device 1A includes a planar coil antenna 10, a high-frequency antenna 20 disposed so as to overlap a part of a left side (in the drawing) of the planar coil antenna 10 in a plan view, and a magnetic sheet 30 disposed so as to overlap a part of a right side (in the drawing) of the planar coil antenna 10 in a plan view and so as not to overlap the high-frequency antenna 20 in a plan view. The part of the planar coil antenna 10 that overlaps the high-frequency antenna 20 does not overlap the magnetic sheet 30, and a part of the planar coil antenna 10 that overlaps the magnetic sheet 30 does not overlap the high-frequency antenna 20.

As illustrated in FIG. 3, the planar coil antenna 10, high-frequency antenna 20, and magnetic sheet 30 are housed inside the housing 50, and the resin cover layer 51A and metal cover layer 51B constituting the housing 50 are disposed on one main surface 10a side of the planar coil antenna 10. On the other hand, the high-frequency antenna 20 and magnetic sheet 30 are disposed on the other main surface 10b side of the planar coil antenna 10. Like the magnetic sheet 30, the metal cover layer 51B is disposed so as to overlap a part of the right side (in the drawing) of the planar coil antenna 10 in a plan view and so as not to overlap the high-frequency antenna 20 in a plan view.

The planar coil antenna 10 has a spiral pattern 10c formed on one main surface 11a of a flexible substrate 11 and is disposed parallel to an XY plain in the present embodiment. In order to facilitate antenna design and to make an area of an inner diameter portion 10d surrounded by the spiral pattern 10c as large as possible, it is preferable that the spiral pattern 10c is a rectangular spiral pattern and includes a linear pattern component extending in an X-direction and a linear pattern component extending in a Y-direction. An outer size of the planar coil antenna 10 is, e.g., 30×40 mm.

In the present embodiment, both ends of the spiral pattern 10c extend to near an edge of the flexible substrate 11. Especially, an inner peripheral end of the spiral pattern 10c passes across the spiral pattern 10c and extends outside the pattern. For example, the both ends of the spiral pattern 10c are connected to an NFC chip (not shown) mounted on the flexible substrate 11 or a main circuit board of the mobile wireless device.

The flexible substrate 11 is made of, e.g., a PET resin, and a planar size thereof is appropriately determined according to a size of the spiral pattern 10c. A thickness of the flexible substrate 11 is, e.g., 30 μm. The flexible substrate 11 is disposed inside the housing 50 such that the one main surface 11a on which the spiral pattern 10c is formed faces outside the housing 50.

The high-frequency antenna 20 includes a rectangular planar conductor (solid pattern), and a power feed line 21 is connected to a back surface thereof. The power feed line 21 is electrically connected between a RF circuit and the high-frequency antenna 20 to transmit a RF signal from the RF circuit to the high-frequency antenna 20. The high-frequency antenna 20 is disposed so as to overlap a part of the planar coil antenna 10 and covers a part of the spiral pattern 10c of the planar coil antenna 10 and a part of the inner diameter portion 10d surrounded by the spiral pattern 10c. The high-frequency antenna 20 may be formed as a metal flat plate, a metal sheet, or a metal foil formed on a surface of a support member.

In the present embodiment, the metal cover layer 51B constitutes a part of the housing 50 and covers a part of the planar coil antenna 10 housed inside the housing 50, but does not cover the high-frequency antenna 20. The high-frequency antenna 20 overlaps the resin cover layer 51A of the housing 50 in a plan view.

In the present embodiment, the magnetic sheet 30 is disposed more inside the housing 50 than the planar coil antenna 10 and is bonded to the other main surface 11b of the flexible substrate 11. A thickness of the magnetic sheet 30 is not especially limited as long as the magnetic sheet 30 can fulfill its function. As illustrated, the planar coil antenna 10 is often mounted in proximity to a battery pack 40 of the mobile wireless device; when the magnetic sheet 30 is interposed between the battery pack 40 and planar coil antenna 10, a magnetic path of magnetic flux generated by current flowing in the planar coil antenna 10 can be ensured. This can suppress influence that a metal body constituting the battery pack 40 has on the planar coil antenna 10, thereby obtaining desired antenna characteristics.

The magnetic sheet 30 is preferably a composite magnetic sheet obtained by combining a magnetic metal powder having a flat form with a high aspect ratio with a polymer. Particles of the flat metal powder overlap one another in a thickness direction of the composite magnetic sheet, and a surface direction of the flat metal powder is oriented substantially parallel to a surface direction of the composite magnetic sheet, whereby effective permeability in the surface direction of the composite magnetic sheet can be enhanced. This allows a magnetic field generated by the planar coil antenna 10 to be pulled inside the magnetic sheet 30 from outside and to be guided in a horizontal direction perpendicular to a coil axis. Further, although the flat magnetic powder is densely arranged in the polymer, particles of the flat magnetic powder are insulated by the polymer from each other, making it possible to prevent occurrence of an eddy current. Thus, it is possible to realize both a high permeability and a low magnetic loss in a use frequency band (e.g., 13.56 MHz) of the planar coil antenna 10.

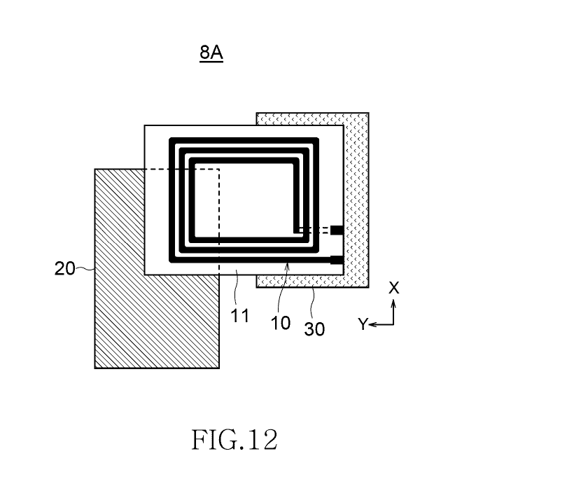

The high-frequency antenna 20 extends substantially parallel to the planar coil antenna 10 from one end portion (left side end portion in the drawing) of the planar coil antenna 10 in the Y-direction to the other end portion (right side end portion in the drawing) thereof, and a part of the high-frequency antenna 20 covers the one end portion of the planar coil antenna 10 in the Y-direction. More in detail, the high-frequency antenna 20 covers the one end portion of the spiral pattern 10c in the Y-direction and a part of the inner diameter portion 10d surrounded by the spiral pattern 10c. The one end portion of the high-frequency antenna 20 in the Y-direction does not overlap the planar coil antenna 10, and the other end portion thereof in the Y-direction is positioned on the one end side of the planar coil antenna 10 in the Y-direction relative to a coil axis Z₀ of the planar coil antenna 10. As illustrated in FIGS. 2A and 2B, an X-direction width W₂ of the high-frequency antenna 20 is larger than an X-direction width W₁ of the planar coil antenna 10 and, accordingly, the high-frequency antenna 20 covers all over the planar coil antenna 10 in the X-direction; however, as illustrated in FIG. 12, the high-frequency antenna 20 may cover only a part of the planar coil antenna 10 in the

X-direction. A size of the high-frequency antenna 20 can appropriately be set according to a resonant frequency thereof.

The high-frequency antenna 20 is disposed on the other main surface 10b side of the planar coil antenna 10, so that characteristics of the planar coil antenna 10 are not significantly deteriorated by influence of the high-frequency antenna 20. Further, the planar coil antenna 10 has a spiral pattern which does not cover a wide area of the high-frequency antenna 20, so that influence that the planar coil antenna 10 has on the high-frequency antenna 20 is small, with the result that the high-frequency antenna 20 operates properly without any problem even when it is disposed so as to overlap the planar coil antenna 10.

The metal cover layer 51B extends from the other end portion (right side end portion in the drawing) of the planar coil antenna 10 in the Y-direction to one end portion (left side end in the drawing) thereof in the Y-direction, and a part of the metal cover layer 51B covers the other end portion of the planar coil antenna 10 in the Y-direction. More in detail, the metal cover layer 51B covers the other end portion of the spiral pattern 10c of the planar coil antenna 10 in the Y-direction and a part of the inner diameter portion 10d surrounded by the spiral pattern 10c.

One end portion of the metal cover layer 51B in the Y-direction that overlaps the planar coil antenna 10 is preferably positioned on the other end side of the planar coil antenna 10 in the Y-direction relative to the coil axis Z₀ of the planar coil antenna 10 without covering the coil axis Z₀. Further, as illustrated in FIGS. 2A and 2B, a region where the metal cover layer 51B overlaps the inner diameter portion 10d of the planar coil antenna 10 in a plan view is a rectangular region, and an area S₁ of the rectangular region is preferably less than 62.5% of a total area S₀ of the inner diameter portion 10d of the planar coil antenna 10, more preferably equal to less than 50%, and still more preferably equal to or more than 12.5% and equal to or less than 50%. In other words, an exposed area of the inner diameter portion 10d of the planar coil antenna 10 that is not covered with the metal cover layer 51B is preferably equal to or more than 37.5% of a total area of the inner diameter portion 10d of the planar coil antenna 10, more preferably more than 50%, and still more preferably more than 50% and less than 87.5%. The inner diameter portion 10d of the planar coil antenna 10 refers to a region inside an innermost periphery of the spiral pattern 10c. In a region where the metal cover layer 51B overlaps the inner diameter portion 10d of the planar coil antenna 10 in a plan view, the entire surface of the metal cover layer 51B is made of metal, and a part where metal is absent, such as an opening or a slit, does not exist.

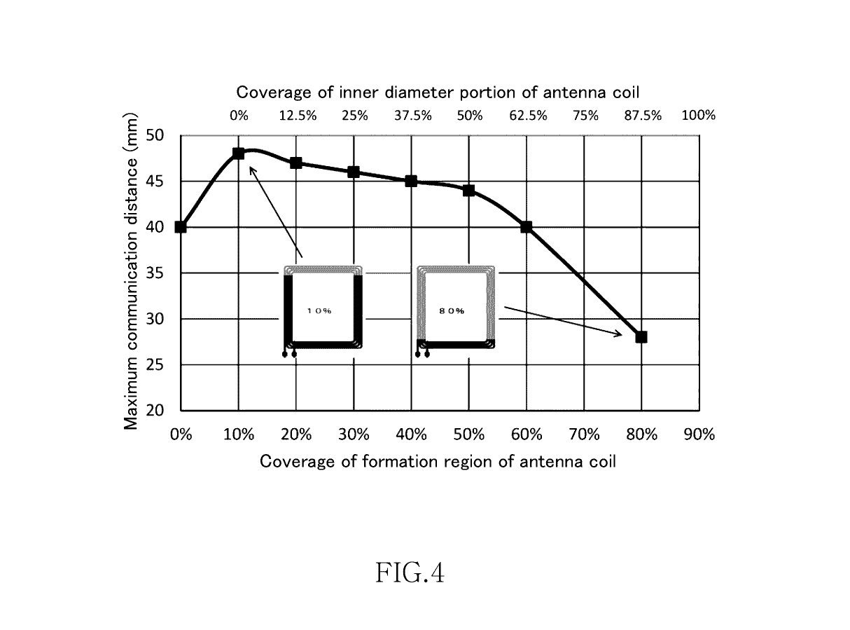

FIG. 4 is a graph illustrating a relationship between a covering area of a planar conductor (corresponding to the metal cover layer 51B) that covers the planar coil antenna 10 and a communication distance of the planar coil antenna 10. A lower horizontal axis represents a ratio (coverage) (%) of the covering area of the planar conductor to a total area of a formation region of the planar coil antenna inner diameter portion. An upper horizontal axis represents a ratio (coverage) (%) of the covering area of the planar conductor to a total area of the inner diameter portion 10d of the planar coil antenna 10. A vertical axis represents a maximum communication distance (mm) of the planar coil antenna in so-called a card mode. The formation region of the planar coil antenna 10 refers to a region inside the outermost periphery of the spiral pattern 10c and includes not only a region where the spiral pattern 10c is actually formed, but also a space between adjacent turns of the spiral pattern 10c and inner diameter portion 10d. The maximum communication distance of the planar coil antenna in a card mode refers to a maximum value of a distance from the planar coil antenna 10 to a reader/writer for use in test when a test signal is transmitted from the testing reader/writer, the planar coil antenna 10 receives the test signal and transmits a modulated signal of the received test signal, and a voltage level of the modulated signal of the test signal received by a search coil satisfies a threshold level. An outer size of the planar coil antenna 10 is 40 mm×50 mm, and the number of turns thereof is three.

As illustrated in FIG. 4, the communication distance of the planar coil antenna 10 is about 40 mm when the coverage of the formation region of the planar coil antenna 10 is 0% and exhibits a maximum value of about 48 mm when the coverage of the formation region of the planar coil antenna 10 is 10%. The communication distance of the planar coil antenna 10 slowly decreases until the coverage reaches 50% and becomes about 44 mm when the coverage is 50%. However, a decrease rate of the communication distance becomes higher after the coverage exceeds 50%, and the communication distance decreases to 40 mm when the coverage is 60% which is the same level as that obtained when the coverage is 0%. When the coverage is 80%, the communication distance decreases to about 28 mm.

A relationship between the coverage of the formation region of the planar coil antenna 10 and coverage of the inner diameter portion 10d of the planar coil antenna 10 is as follows. When the coverage of the formation region of the planar coil antenna 10 is less than 10%, the coverage of the inner diameter portion 10d of the planar coil antenna 10 is 0%. Then, as the coverage of the formation region of the planar coil antenna 10 increases, the coverage of the inner diameter portion 10d of the planar coil antenna 10 increases, and when the coverage of the formation region of the planar coil antenna 10 is 40%, 50%, and 60%, the coverage of the inner diameter portion 10d of the planar coil antenna 10 becomes 37.5%, 50%, and 62.5%, respectively. When the coverage of the formation region of the planar coil antenna 10 is 90%, the coverage of the inner diameter portion 10d of the planar coil antenna 10 becomes 100%.

The above results reveal that the area S₁ of the region where the metal cover layer 51B overlaps the inner diameter portion 10d of the planar coil antenna 10 in a plan view is preferably less than 62.5% of the total area S₀ of the inner diameter portion 10d of the planar coil antenna 10, more preferably equal to or less than 50% in consideration of a margin, and still more preferably, equal to or more than 12.5% and equal to or less than 50%. With this configuration, it is possible to increase the communication distance of the planar coil antenna 10 by suppressing influence that the metal cover layer 51B has on the planar coil antenna 10, thereby achieving both ensuring of antenna characteristics and space saving.

Like the metal cover layer 51B, the magnetic sheet 30 extends from the other end portion (right side end portion in the drawing) of the planar coil antenna 10 in the Y-direction from the one end portion (left side end portion in the drawing) thereof in the Y-direction, and a part of the magnetic sheet 30 overlaps the other end portion of the planar coil antenna 10 in the Y-direction. In order to sufficiently ensure a magnetic path of magnetic flux that crosses the planar coil antenna 10, the magnetic sheet 30 is preferably disposed so as to overlap the entire region of the planar coil antenna 10; however, when the high-frequency antenna 20 is disposed in proximity to the magnetic sheet 30, characteristics of the high-frequency antenna 20 may be deteriorated. Thus, the magnetic sheet 30 is disposed so as not to overlap the high-frequency antenna 20.

A Y-direction one end portion of the magnetic sheet 30 that overlaps the planar coil antenna 10 is preferably disposed so as not to protrude outside the metal cover layer 51B, as illustrated. That is, the one end portion of the magnetic sheet 30 in the Y-direction is preferably positioned on the other end side of the metal cover layer 51B in the Y-direction relative to the one end portion thereof in the Y-direction. By disposing the magnetic sheet 30 at a position further than the metal cover layer 51B as viewed from the high-frequency antenna 20 in the Y-direction as described above, it is possible to minimize influence that the magnetic sheet 30 has on the high-frequency antenna 20, thereby ensuring desired antenna characteristics.

The other end portion of the magnetic sheet 30 in the Y-direction and both end portions of the magnetic sheet 30 in the X-direction may protrude outside the flexible substrate 11 as illustrated or may be positioned within a region of the flexible substrate 11 without protruding outside the flexible substrate 11. Further, the magnetic sheet 30 may be bonded to a back surface 11b of the flexible substrate 11 as illustrated or may be disposed spaced apart from the flexible substrate 11.

As illustrated in FIG. 1, a part of the back surface 50b of the housing 50 where the metal cover layer 51B is absent, i.e., a space inside the housing 50 where the antenna can be mounted is very limited, so that it is difficult to mount the planar coil antenna 10 and high-frequency antenna 20 such that they do not overlap each other and do not completely overlap the metal cover layer 51B. On the other hand, it has hitherto been thought that the planar coil antenna 10 and high-frequency antenna 20 must be disposed so as not to overlap each other. However, by disposing a part of the planar coil antenna 10 such that it overlaps the metal cover layer 51B, and disposing the high-frequency antenna 20 such that it overlaps a part of the planar coil antenna 10, it is possible to efficiently lay out both the planar coil antenna 10 and high-frequency antenna 20 within the space that is not covered with the metal cover layer 51B.

In order to make the planar coil antenna 10 operate stably, it is necessary to dispose the magnetic sheet 30 on the other main surface 10b side of the planar coil antenna 10. When the magnetic sheet 30 overlaps the high-frequency antenna 20 under such a condition, radiation characteristics of the high-frequency antenna 20 are deteriorated. However, in the present embodiment, the magnetic sheet 30 is disposed so as to overlap the planar coil antenna 10 in a plan view and so as not to overlap the high-frequency antenna 20, so that it is possible to make both the planar coil antenna 10 and high-frequency antenna 20 operate stably.

As described above, the antenna device 1A according to the present embodiment includes the planar coil antenna 10 for NFC and high-frequency antenna 20, and the high-frequency antenna 20 is disposed so as to overlap a part of the planar coil antenna 10 in a plan view, so that it is possible to efficiently lay out both the planar coil antenna 10 and high-frequency antenna 20 within a limited space inside the housing 50 of the mobile wireless device 100A while ensuring desired antenna characteristics of the planar coil antenna 10 and high-frequency antenna 20. Further, the magnetic sheet 30 is disposed so as to overlap a part of the planar coil antenna 10 in a plan view, so that the planar coil antenna 10 can ensure desired antenna characteristics without being influenced by a metal body such as a battery pack. Further, the magnetic sheet 30 is disposed so as not to overlap the high-frequency antenna 20 in a plan view, so that it is possible to prevent characteristics of the high-frequency antenna 20 from being deteriorated, thereby ensuring satisfactory communication performance of the high-frequency antenna 20.

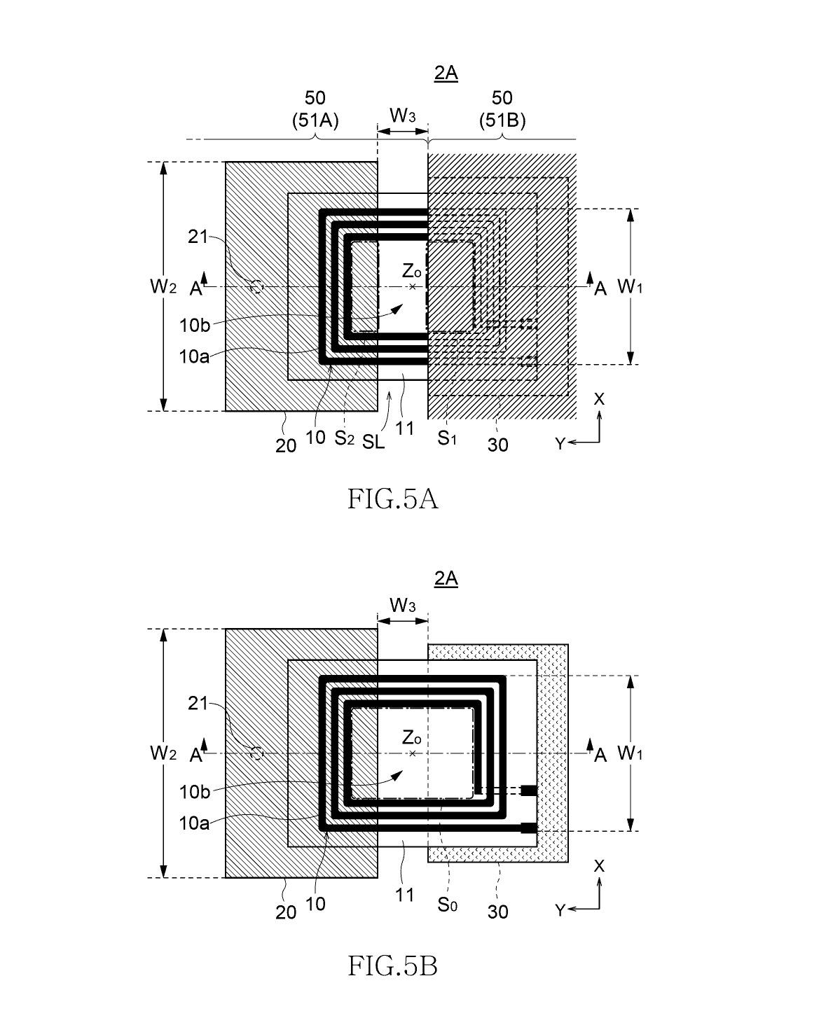

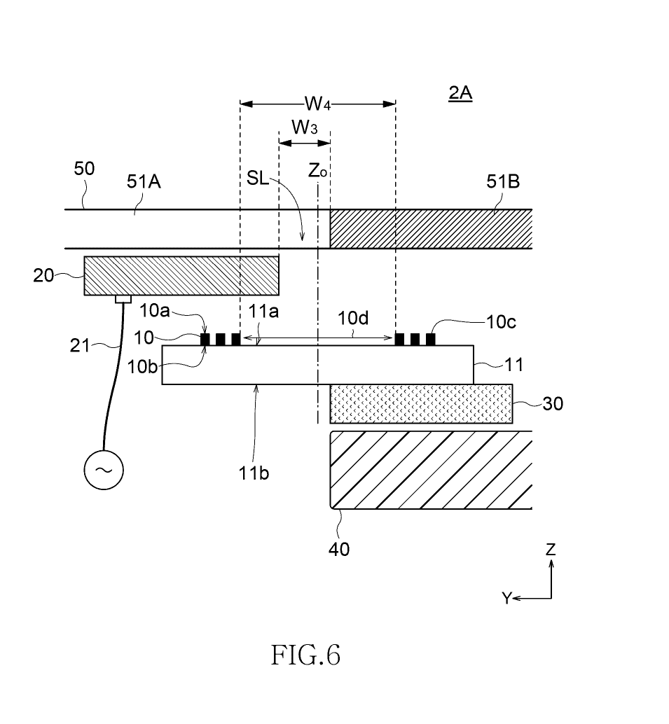

FIGS. 5A and 5B are plan views each transparently illustrating a configuration of an antenna device 2A according to a second embodiment of the present invention. FIG. 5A illustrates a state where the housing 50 (especially, metal cover layer 51B) is present, and FIG. 5B illustrates a state where the housing 50 is omitted. FIG. 6 is a cross-sectional view of the antenna device 2A taken along a line A-A of FIGS. 5A and 5B.

As illustrated in FIGS. 5A and 5B and FIG. 6, the antenna device 2A has a feature in that the high-frequency antenna 20 is disposed on the one main surface 10a side of the planar coil antenna 10. Other configurations are the same as those of the first embodiment.

When the high-frequency antenna 20 is disposed on the one main surface 10a side of the planar coil antenna 10, a part of the planar coil antenna 10 is covered with the high-frequency antenna 20 in a plan view, a shielding effect by the high-frequency antenna 20 poses a problem. That is, a planar conductor constituting the high-frequency antenna 20 shields radio waves radiated from the planar coil antenna 10, so that, in some cases, the planar coil antenna 10 cannot be made to operate properly. In addition to a case where a single body of the high-frequency antenna 20 widely covers the planar coil antenna 10, a case where a combination of the high-frequency antenna 20 and metal cover layer 51B widely covers the planar coil antenna 10 also causes this problem. In either case, radio waves from the planar coil antenna 10 cannot be sufficiently radiated outside the housing 50, with the result that a radiation efficiency of the planar coil antenna 10 may be significantly deteriorated.

To solve the above problem, a slit region SL having a certain width is formed between the high-frequency antenna 20 and metal cover layer 51B when viewed in the Z-direction perpendicular to the XY plane. The slit region SL is a linear non-shielded region extending in the X-direction. A width W₃ of the slit region SL is preferably equal to or larger than 1/10 and, more preferably, equal to or larger than ⅕ of a width W₄ of the inner diameter portion 10d of the planar coil antenna 10 in the same direction. The slit region SL serves as a magnetic path of magnetic flux that crosses the planar coil antenna 10, so that it is possible to make the planar coil antenna 10 operate properly.

The other end portion of the high-frequency antenna 20 in the Y-direction that overlaps the planar coil antenna 10 is preferably positioned on the one end side of the planar coil antenna 10 in the Y-direction relative to the coil axis Z₀ of the planar coil antenna 10 without overlapping the coil axis Z₀. Further, as illustrated in FIGS. 5A and 5B, a sum of an area S₂ of a region where the high-frequency antenna 20 overlaps the inner diameter portion 10d of the planar coil antenna 10 in a plan view and the area S₁ of the region where the metal cover layer 51B overlaps the inner diameter portion 10d of the planar coil antenna 10 in a plan view is preferably less than 62.5% of the total area S₀ of the inner diameter portion 10d of the planar coil antenna 10, more preferably, equal to less than 50%, and still more preferably, equal to or more than 12.5% and equal to or less than 50%. With this configuration, it is possible to increase the communication distance of the planar coil antenna 10 by suppressing influence that the high-frequency antenna 20 and metal cover layer 51B have on the planar coil antenna 10, thereby achieving both ensuring of antenna characteristics and space saving.

Further, in the present embodiment, the slit region SL that overlaps the inner diameter portion 10d of the planar coil antenna 10 is formed, so that it is possible to ensure desired radiation characteristics of the planar coil antenna 10. A part of magnetic flux that passes the inner diameter portion 10d of the planar coil antenna 10 and the slit region SL widely circles outside the high-frequency antenna 20 and metal cover layer 51B and returns back to the inner diameter portion 10d of the planar coil antenna 10, so that the communication distance of the planar coil antenna 10 can be increased. Therefore, even when a small-sized planar coil antenna is used, desired antenna characteristics required for NFC can be ensured.

As described above, the antenna device 2A according to the present embodiment can have the same effects as those of the first embodiment. Further, there is no member that influences electromagnetic waves to be radiated from the high-frequency antenna 20 outside the high-frequency antenna 20, so that radiation characteristics of the high-frequency antenna 20 can be improved.

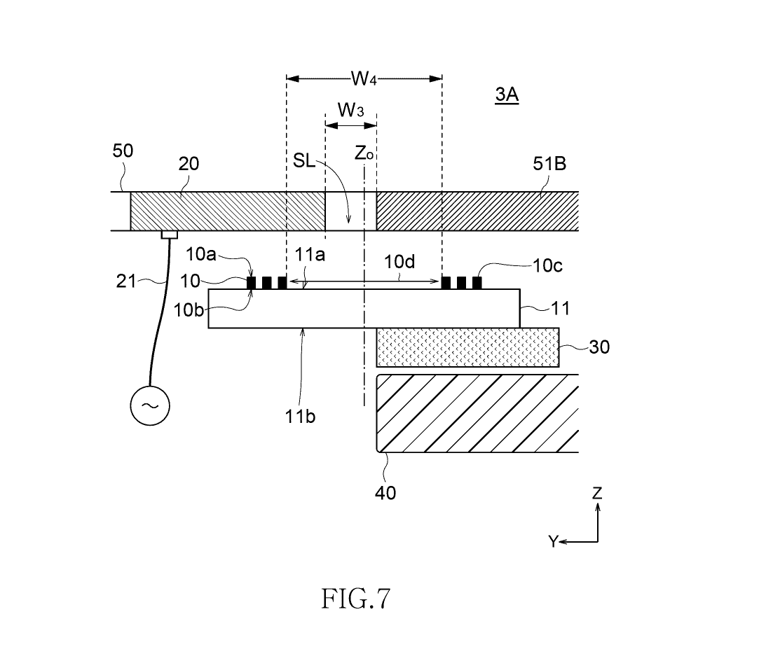

FIG. 7 is a schematic cross-sectional view of an antenna device 3A according to a third embodiment of the present invention.

As illustrated in FIG. 7, the antenna device 3A has a feature in that the high-frequency antenna 20 constitutes a part of the housing 50 of the mobile wireless device. That is, in the present embodiment, apart of the metal cover layer 51B constituting the housing 50 is used as the high-frequency antenna 20. Other configurations are the same as those of the second embodiment. According to the present embodiment, in addition to the effects obtained by the second embodiment, it is possible to eliminate the need to ensure amounting space of the high-frequency antenna 20 inside the housing 50, thereby enhancing a degree of freedom of layout of the planar coil antenna 10. Further, there is no member that influences electromagnetic waves to be radiated from the high-frequency antenna 20 outside the high-frequency antenna 20, so that radiation characteristics of the high-frequency antenna 20 can be improved.

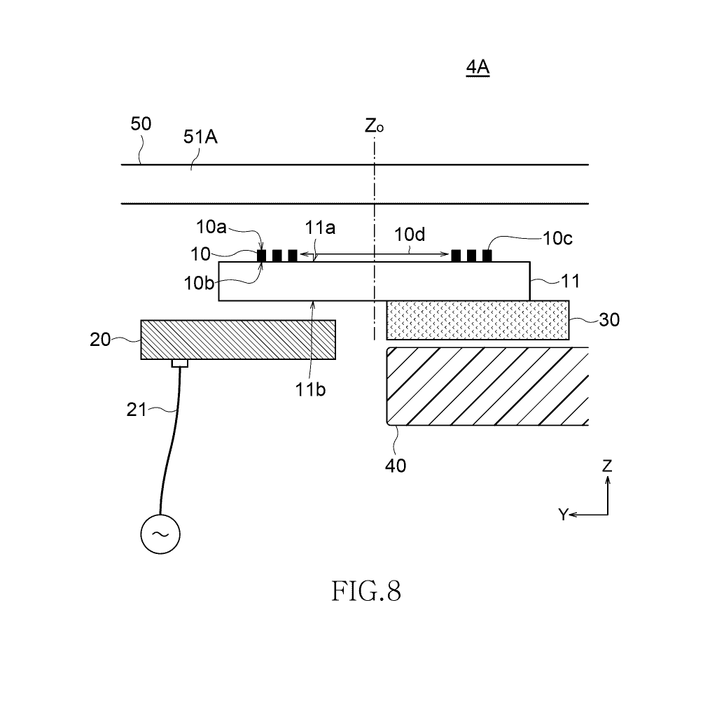

Hereinafter, with reference to FIGS. 8 to 10, embodiments of an antenna device that uses the housing 50 having no metal cover layer 51B will be described in detail.

FIG. 8 is a schematic cross-sectional view of an antenna device 4A according to a fourth embodiment of the present invention.

As illustrated in FIG. 8, the antenna device 4A has a feature in that, in the configuration of the antenna device 1A according to the first embodiment, the housing 50 does not have the metal cover layer 51B but is constituted only by the resin cover layer 51A. Other configurations are the same as those of the first embodiment.

The antenna device 4A according to the present embodiment includes the planar coil antenna 10 for NFC and high-frequency antenna 20, and the high-frequency antenna 20 is disposed so as to overlap a part of the planar coil antenna 10 in a plan view, so that it is possible to efficiently lay out both the planar coil antenna 10 and high-frequency antenna 20 within a limited space inside the housing 50 of the mobile wireless device 100A while ensuring desired antenna characteristics of the planar coil antenna 10 and high-frequency antenna 20. Further, the magnetic sheet 30 is disposed so as to overlap a part of the planar coil antenna 10 in a plan view, so that the planar coil antenna 10 can ensure desired antenna characteristics without being influenced by a metal body such as a battery pack. Further, the magnetic sheet 30 is disposed so as not to overlap the high-frequency antenna 20 in a plan view, so that it is possible to prevent characteristics of the high-frequency antenna 20 from being deteriorated, thereby ensuring satisfactory communication performance of the high-frequency antenna 20.

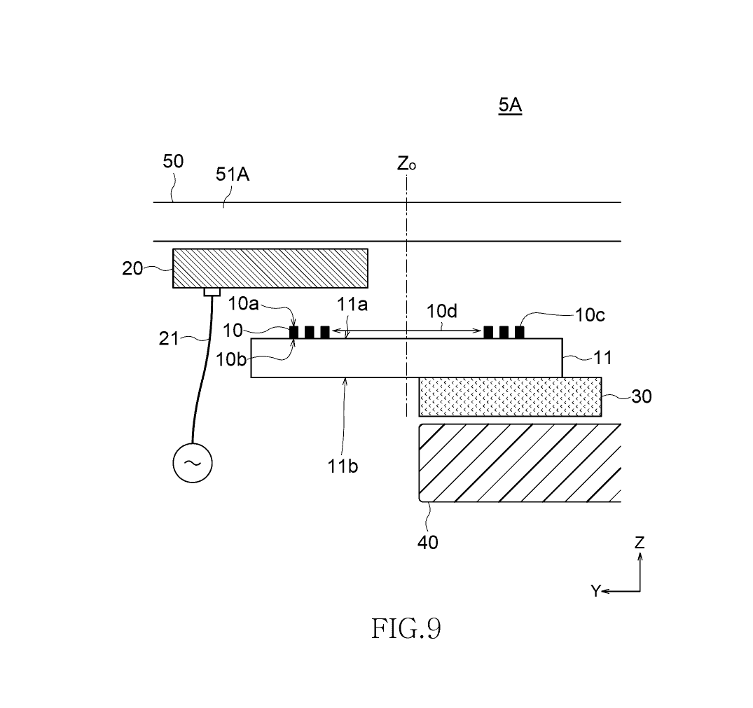

FIG. 9 is a schematic cross-sectional view of an antenna device 5A according to a fifth embodiment of the present invention.

As illustrated in FIG. 9, the antenna device 5A has a feature in that, in the configuration of the antenna device 2A according to the second embodiment, the housing 50 does not have the metal cover layer 51B but is constituted only by the resin cover layer 51A. Other configurations are the same as those of the second embodiment.

The other end portion of the high-frequency antenna 20 in the Y-direction that overlaps the planar coil antenna 10 is preferably positioned on the one end side of the planar coil antenna 10 in the Y-direction relative to the coil axis Z₀ of the planar coil antenna 10 without covering the coil axis Z₀. Further, the area S₂ (see FIG. 5A) of the region where the high-frequency antenna 20 overlaps the inner diameter portion 10d of the planar coil antenna 10 in a plan view is preferably less than 62.5% of the total area S₀ of the inner diameter portion 10d of the planar coil antenna 10, more preferably, equal to less than 50%, and still more preferably, equal to or more than 12.5% and equal to or less than 50%. With this configuration, it is possible to increase the communication distance of the planar coil antenna 10 by suppressing influence that the high-frequency antenna 20 has on the planar coil antenna 10, thereby achieving both ensuring of antenna characteristics and space saving.

As described above, the antenna device 5A according to the present embodiment can have the same effects as those of the second embodiment. Further, there is no member that influences radio waves to be radiated from the high-frequency antenna 20 outside the high-frequency antenna 20, so that radiation characteristics of the high-frequency antenna 20 can be improved.

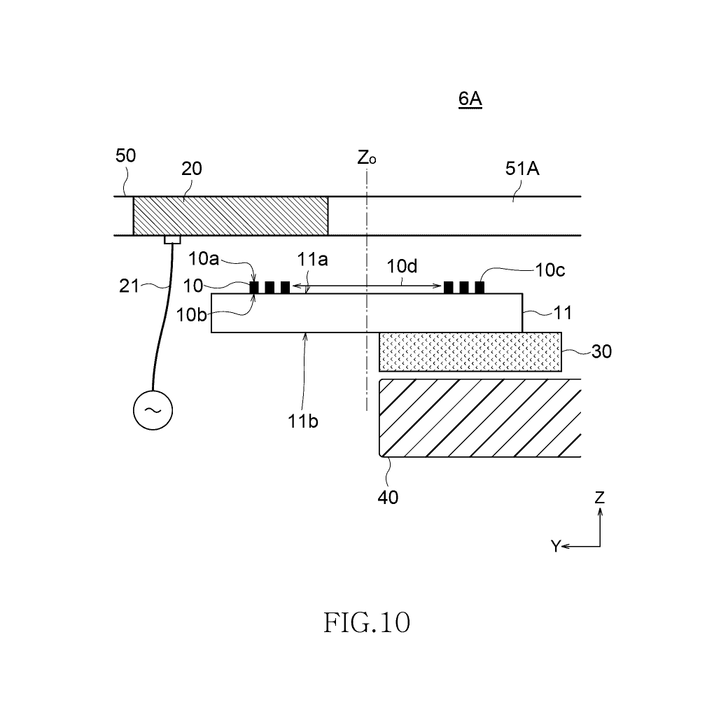

FIG. 10 is a schematic cross-sectional view of an antenna device 6A according to a sixth embodiment of the present invention.

As illustrated in FIG. 10, the antenna device 6A has a feature in that, in the configuration of the antenna device 3A according to the third embodiment, the housing 50 does not have the metal cover layer 51B but is constituted only by the resin cover layer 51A. Other configurations are the same as those of the second embodiment. The antenna device 6A having the above configuration can have the same effects as those of the third embodiment. Further, there is no member that influences electromagnetic waves to be radiated from the high-frequency antenna 20 outside the high-frequency antenna 20, so that radiation characteristics of the high-frequency antenna 20 can be improved.

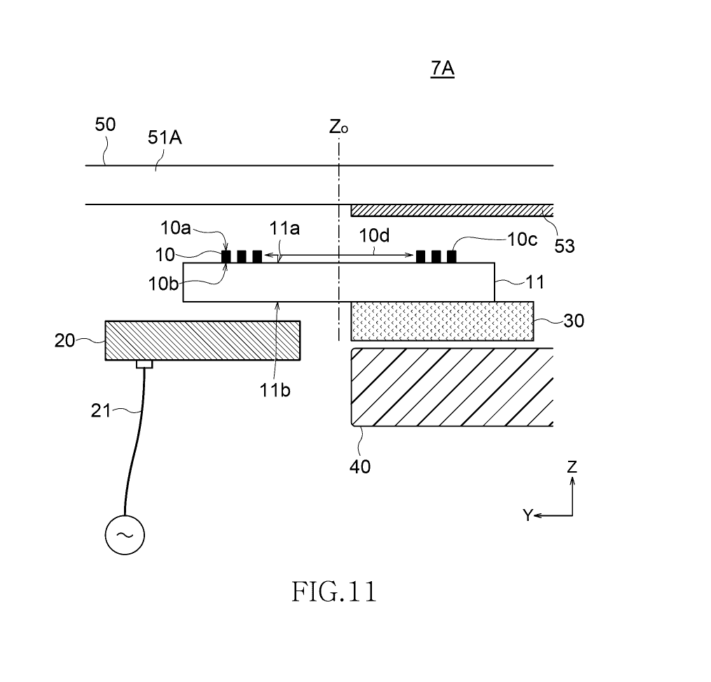

FIG. 11 is a schematic cross-sectional view of an antenna device 7A according to a seventh embodiment of the present invention.

As illustrated in FIG. 11, the antenna device 7A has a feature in that, in the configuration of the antenna device 1A according to the first embodiment, the housing 50 is constituted only by the resin cover layer 51A, and a metal film 53 is formed on an inner surface of the resin cover layer 51A. The antenna device 7A having the above configuration can have the same effects as those of the first embodiment.

FIG. 12 is a schematic plan view illustrating a configuration of an antenna device 8A according to an eighth embodiment of the present invention. FIG. 12 particularly illustrates a modification of the layout of the high-frequency antenna 20.

As illustrated in FIG. 12, the antenna device 8A has a feature in that the high-frequency antenna 20 is offset in the X-direction relative to the planar coil antenna 10. Thus, the high-frequency antenna 20 overlaps, not the entire planar coil antenna 10, but a part thereof in the X-direction. As described above, an X-direction center position of the high-frequency antenna 20 and an X-direction center of the planar coil antenna 10 need not be aligned with each other. The antenna device 8A according to the present embodiment can have the same effects as those of the first embodiment.

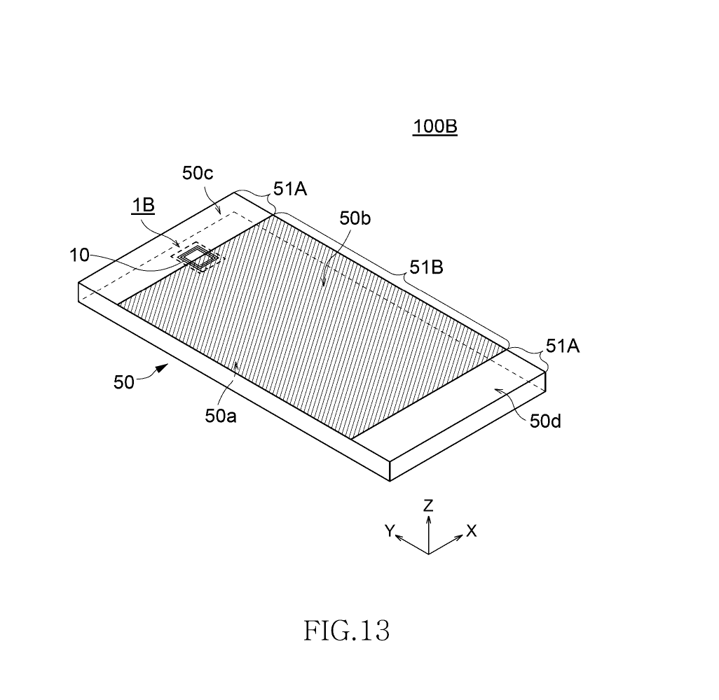

FIG. 13 is a schematic perspective view illustrating a configuration of a mobile wireless device 100B including an antenna device 1B according to a ninth embodiment of the present invention.

As illustrated in FIG. 13, the mobile wireless device 100B according to the present embodiment is, e.g., a smartphone and has a very thin housing 50. In FIG. 13, the back surface 50b of the housing 50 faces upward, and a front surface 50a of the housing 50 on which a display is mainly disposed faces downward. The housing 50 is made of a combination of a resin and a metal, and a metal cover layer 51B is formed in a wide area thereof including a center portion of the back surface 50b. Further, a resin cover layer 51A is formed on one end portion (upper end portion 50c) and the other end portion (lower end portion 50d) of the back surface 50b of the housing 50 in a longitudinal direction (Y-direction). The resin cover layer 51A is a non-shielded region where the metal cover layer 51B is not formed. The metal cover layer 51B is provided for improving mechanical strength, electromagnetic shielding characteristics, and designability of the housing.

The mobile wireless device 100B incorporates the antenna device 1B. The antenna device 1B is disposed in the upper end portion 50c of the housing 50. The antenna device 1B according to the present embodiment includes the planar coil antenna 10 used for HF-band wireless communication but does not include the high-frequency antenna 20 (see FIG. 1) used for UHF-band wireless communication provided in the first embodiment. The planar coil antenna 10 is, e.g., an NFC antenna and has a resonant frequency of 13.56 MHz.

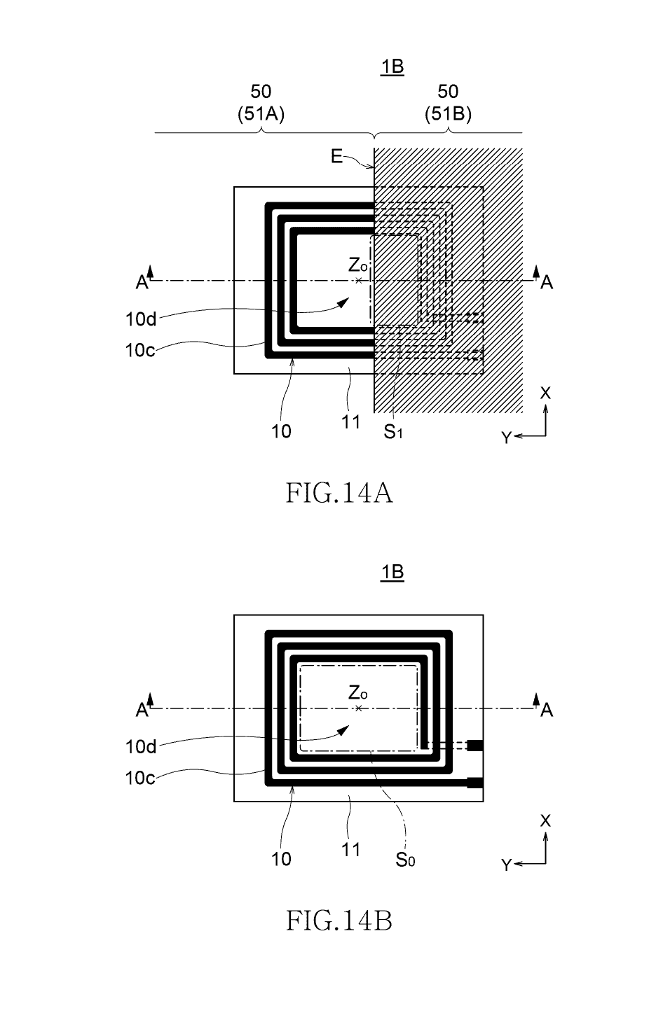

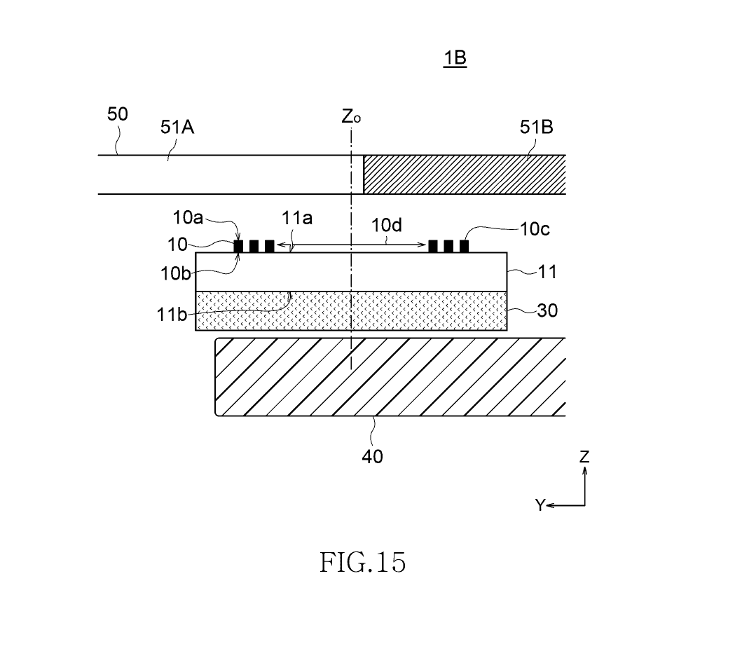

FIGS. 14A and 14B are plan views each transparently illustrating a configuration of the antenna device 1B illustrated in FIG. 13. FIG. 14A illustrates a state where the housing 50 (especially, metal cover layer 51B) is present, and FIG. 14B illustrates a state where the housing 50 is omitted. FIG. 15 is a substantially cross-sectional view of the antenna device 1B taken along a line A-A of FIGS. 14A and 14B.

As illustrated in FIGS. 14A, 14B, and FIG. 15, the antenna device 1B includes the planar coil antenna 10 housed inside the housing 50. The housing 50 is constituted by the resin cover layer 51A and metal cover layer 51B and is disposed opposite to one main surface 10a of the planar coil antenna 10.

The planar coil antenna 10 has the spiral pattern 10c formed on one main surface 11a of the flexible substrate 11 and is disposed parallel to an XY plain in the present embodiment. In order to facilitate antenna design and to make an area of the inner diameter portion 10d surrounded by the spiral pattern 10c as large as possible, it is preferable that the spiral pattern 10c is a rectangular spiral pattern and includes a linear pattern component extending in the X-direction and a linear pattern component extending in the Y-direction. An outer size of the planar coil antenna 10 is, e.g., 40×50 mm.

In the present embodiment, both ends of the spiral pattern 10c extend to near an edge of the flexible substrate 11. Especially, an inner peripheral end of the spiral pattern 10c passes across the spiral pattern 10c and extends outside the pattern. For example, the both ends of the spiral pattern 10c are connected to an NFC chip (not mounted) mounted on the flexible substrate 11 or a main circuit board of the mobile wireless device.

The flexible substrate 11 is made of, e.g., a PET resin, and a planar size thereof is appropriately determined according to a size of the spiral pattern 10c. A thickness of the flexible substrate 11 is, e.g., 30 μm.

The metal cover layer 51B is a planar conductor that constitutes a part of the housing 50. The metal cover layer 51B is opposed to the one main surface 10a of the planar coil antenna 10 and covers a part of the planar coil antenna 10 from above. The metal cover layer 51B is disposed so as to overlap a part of the planar coil antenna 10 in a plan view and covers a part of the spiral pattern 10c of the planar coil antenna 10 and a part of the inner diameter portion 10d surrounded by the spiral pattern 10c. Further, a linear edge E constituting one side of the metal cover layer 51B extends in the X-direction and passes across the inner diameter portion 10d.

The magnetic sheet 30 is disposed on the other main surface 10b side of the planar coil antenna 10. In the present embodiment, the magnetic sheet 30 is bonded to the other main surface 11b of the flexible substrate 11. A thickness of the magnetic sheet 30 is not especially limited as long as the magnetic sheet 30 can fulfill its function. As illustrated, the planar coil antenna 10 is often mounted in proximity to the battery pack 40 of the mobile wireless device; when the magnetic sheet 30 is interposed between the battery pack 40 and planar coil antenna 10, the magnetic path of magnetic flux generated by current flowing in the planar coil antenna 10 can be ensured. This can suppress influence that a metal body constituting the battery pack 40 has on the planar coil antenna 10, thereby obtaining desired antenna characteristics.

The magnetic sheet 30 is preferably a composite magnetic sheet obtained by combining a magnetic metal powder having a flat form with a high aspect ratio with a polymer. Particles of the flat metal powder overlap one another in a thickness direction of the composite magnetic sheet, and a surface direction of the flat metal powder is oriented substantially parallel to a surface direction of the composite magnetic sheet, whereby effective permeability in the surface direction of the composite magnetic sheet can be enhanced. This allows a magnetic field generated by the planar coil antenna 10 to be pulled inside the magnetic sheet 30 from outside and to be guided in a horizontal direction perpendicular to the coil axis Z₀. Further, although the flat magnetic powder is densely arranged in the polymer, particles of the flat magnetic powder are insulated by the polymer from each other, making it possible to prevent occurrence of an eddy current. Thus, it is possible to realize both a high permeability and a low magnetic loss in a use frequency band (e.g., 13.56 MHz) of the planar coil antenna 10.

The metal cover layer 51B extends from one end portion (right side end portion in the drawing) of the planar coil antenna 10 in the Y-direction to the other end portion (left side end in the drawing) thereof in the Y-direction, and a part of the metal cover layer 51B covers the one end portion of the planar coil antenna 10 in the Y-direction. The other end portion of the metal cover layer 51B in the Y-direction that overlaps the planar coil antenna 10 is preferably positioned on the one end side of the planar coil antenna 10 in the Y-direction relative to the coil axis Z₀ of the planar coil antenna 10 without covering the coil axis Z₀. The other end portion of the planar coil antenna 10 in the Y-direction is not covered with the metal cover layer 51B.

Further, as illustrated in FIGS. 14A and 14B, a region where the metal cover layer 51B overlaps the inner diameter portion 10d of the planar coil antenna 10 in a plan view is a rectangular region, and an area S₁ of the rectangular region is preferably less than 62.5% of a total area S₀ of the inner diameter portion 10d of the planar coil antenna 10, more preferably equal to less than 50%, and still more preferably equal to or more than 12.5% and equal to or less than 50%. In other words, an exposed area of the inner diameter portion 10d of the planar coil antenna 10 that is not covered with the metal cover layer 51B is preferably equal to or more than 37.5% of a total area of the inner diameter portion 10d of the planar coil antenna 10, more preferably more than 50%, and still more preferably more than 50% and less than 87.5%. The inner diameter portion 10d of the planar coil antenna 10 refers to a region inside an innermost periphery of the spiral pattern 10c. In a region where the metal cover layer 51B overlaps the inner diameter portion 10d of the planar coil antenna 10 in a plan view, the entire surface of the metal cover layer 51B is made of metal, and a part where metal is absent, such as an opening or a slit, does not exist.

A relationship between a covering area of a planar conductor (corresponding to the metal cover layer 51B) that covers the planar coil antenna 10 and a communication distance of the planar coil antenna 10 is shown in FIG. 4.

As described with reference to FIG. 4, the area S₁ of the region where the metal cover layer 51B overlaps the inner diameter portion 10d of the planar coil antenna 10 in a plan view is preferably less than 62.5% of the total area S₀ of the inner diameter portion 10d of the planar coil antenna 10, more preferably equal to or less than 50% in consideration of a margin, and still more preferably, equal to or more than 12.5% and equal to or less than 50%. With this configuration, it is possible to increase the communication distance of the planar coil antenna 10 by suppressing influence that the metal cover layer 51B has on the planar coil antenna 10, thereby achieving both ensuring of antenna characteristics and space saving.

As described above, the antenna device 1B according to the present embodiment includes the planar coil antenna 10 and metal cover layer 51B that overlaps a part of the planar coil antenna 10 in a plan view, and the region where the metal cover layer 51B overlaps the inner diameter portion 10d of the planar coil antenna 10 is less than 62.5% of the total area of the inner diameter portion 10d of the planar coil antenna 10, so that it is possible to efficiently lay out the planar coil antenna 10 within a limited space inside the housing 50 of the mobile wireless device 100B while ensuring satisfactory antenna characteristics of the planar coil antenna 10.

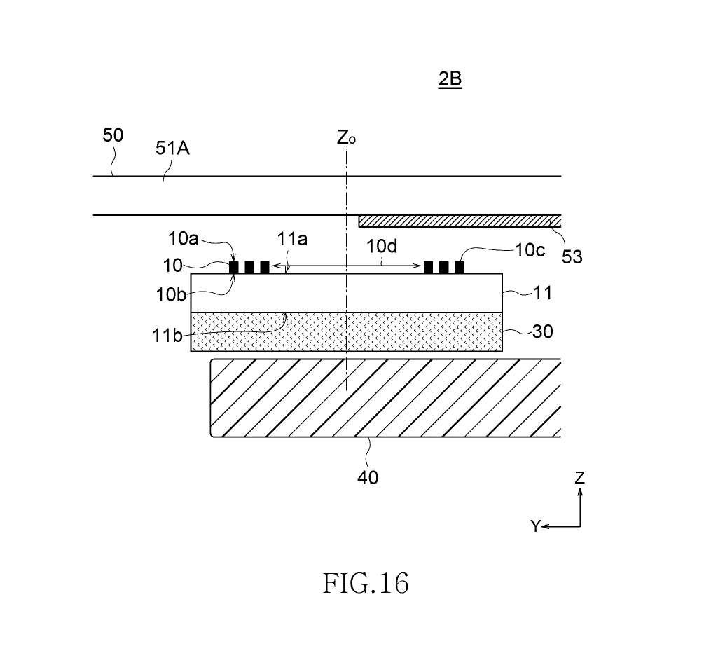

FIG. 16 is a schematic cross-sectional view illustrating a configuration of an antenna device 2B according to a tenth embodiment of the present invention.

As illustrated in FIG. 16, the antenna device 2B is a modification of the antenna device 1B according to the ninth embodiment and has a feature in that the housing 50 is constituted only by the resin cover layer 51A and that the metal film 53 (planar conductor) is formed on an inner surface of the resin cover layer 51A. The other configurations are the same as those of the first embodiment. The antenna device 2B according to the present embodiment can also have the same effects as those of the first embodiment.

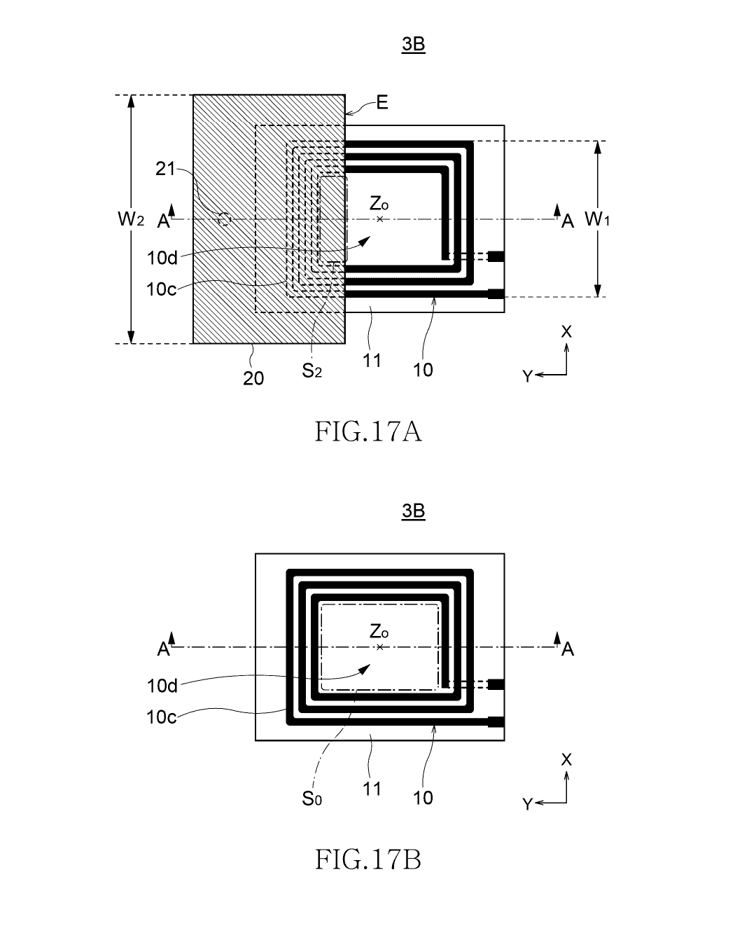

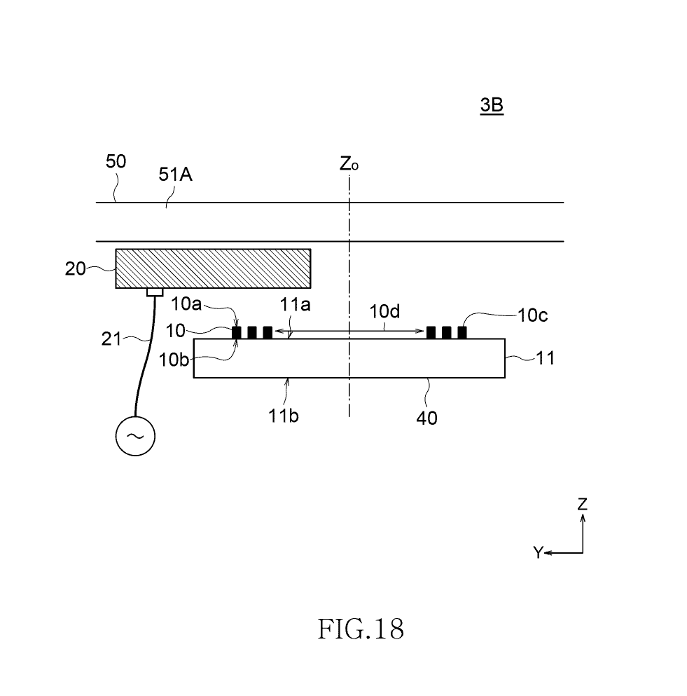

FIGS. 17A and 17B are plan views each transparently illustrating a configuration of the antenna device 3B according to an eleventh embodiment of the present invention. FIG. 17A illustrates a state where the high-frequency antenna is present, and FIG. 17B illustrates a state where the high-frequency antenna is omitted. FIG. 18 is a cross-sectional view of the antenna device 3B taken along a line A-A of FIGS. 17A and 17B.

As illustrated in FIGS. 17A and 17B and FIG. 18, the antenna device 3B has a feature in that a planar conductor that covers a part of the planar coil antenna 10 is not the metal cover layer 51B of the housing 50, but the high-frequency antenna 20 used for UHF-band wireless communication. The housing 50 is not provided with the metal cover layer 51B and is constituted only by the resin cover layer 51A. The other configurations are the same as those of the first embodiment.

The high-frequency antenna 20 includes a rectangular planar conductor (solid pattern), and the power feed line 21 is connected to a back surface thereof. The high-frequency antenna 20 may be formed as a metal flat plate, a metal sheet, or a metal foil formed on a surface of a support member. The high-frequency antenna 20 is disposed on one main surface 10a side of the planar coil antenna 10 so as to cover the planar coil antenna 10 from above. In terms of the Z-direction, the high-frequency antenna 20 is positioned between the planar coil antenna 10 and housing 50. The high-frequency antenna 20 is disposed so as to overlap a part of the planar coil antenna 10 and covers a part of the spiral pattern 10c of the planar coil antenna 10 and a part of the inner diameter portion 10d surrounded by the spiral pattern 10c. Further, a linear edge E constituting one side of the high-frequency antenna 20 extends in the X-direction and passes across the inner diameter portion 10d.

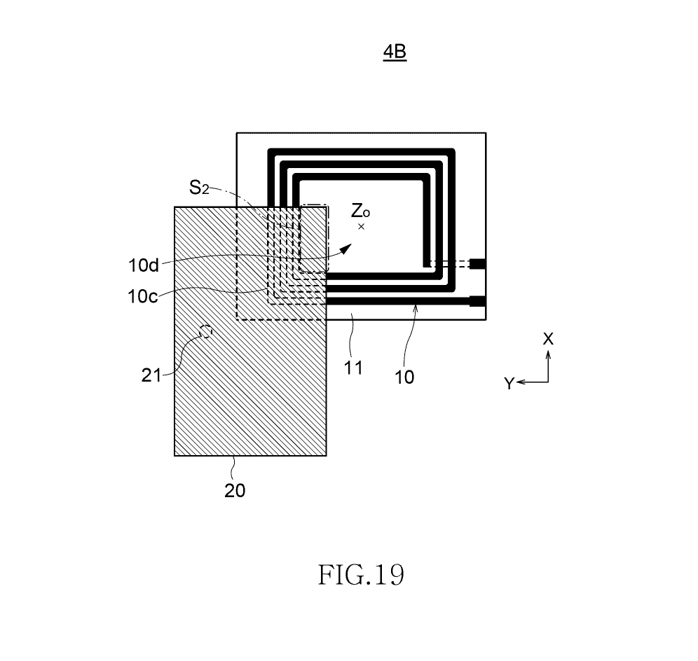

As illustrated in FIGS. 17A and 17B, an X-direction width W₂ of the high-frequency antenna 20 is larger than an x-direction width W₁ of the planar coil antenna 10 and, accordingly, the high-frequency antenna 20 covers all over the planar coil antenna 10 in the X-direction; however, as described later, the high-frequency antenna 20 may cover only a part of the planar coil antenna 10 in the X-direction (see FIG. 19). A size of the high-frequency antenna 20 can appropriately be set according to a resonant frequency thereof.

The high-frequency antenna 20 extends substantially parallel to the planar coil antenna 10 from one end portion (left side end portion in the drawing) of the planar coil antenna 10 in the Y-direction to the other end portion (right side end portion in the drawing) thereof, and a part of the high-frequency antenna 20 covers the one end portion of the planar coil antenna 10 in the Y-direction. The other end portion of the high-frequency antenna 20 in the Y-direction that overlaps the planar coil antenna 10 is preferably positioned on the one end side of the planar coil antenna 10 in the Y-direction relative to the coil axis Z₀ of the planar coil antenna 10 without covering the coil axis Z₀. The other end portion of the planar coil antenna 10 in the Y-direction is not covered with the high-frequency antenna 20.

As illustrated in FIGS. 17A and 17B, the area S₂ of the region where the high-frequency antenna 20 overlaps the inner diameter portion 10d of the planar coil antenna 10 in a plan view is preferably less than 62.5% of the total area S₀ of the inner diameter portion 10d of the planar coil antenna 10, more preferably equal to or less than 50% in consideration of a margin, and still more preferably, equal to or more than 12.5% and equal to or less than 50%. With this configuration, as in the first embodiment, it is possible to increase the communication distance of the planar coil antenna 10 by suppressing influence that the high-frequency antenna 20 has on the planar coil antenna 10, thereby achieving both ensuring of antenna characteristics and space saving.

As described above, the antenna device 3B according to the present embodiment includes the planar coil antenna 10 and high-frequency antenna 20 that overlaps a part of the planar coil antenna 10 in a plan view, and the area of the region where the high-frequency antenna 20 overlaps the inner diameter portion 10d of the planar coil antenna 10 is less than 62.5% of the total area of the inner diameter portion 10d of the planar coil antenna 10, so that it is possible to efficiently lay out the planar coil antenna 10 and high-frequency antenna 20 within a limited space inside the housing 50 of the mobile wireless device 100B while ensuring satisfactory antenna characteristics of the planar coil antenna 10 and high-frequency antenna 20.

FIG. 19 is a schematic plan view of illustrating a configuration of an antenna device 4B according to a twelfth embodiment of the present invention. FIG. 19 particularly illustrates a modification of the layout of the high-frequency antenna 20.

As illustrated in FIG. 19, the antenna device 4B is a modification of the antenna device 3B according to the eleventh embodiment and has a feature in that the high-frequency antenna 20 is offset in the X-direction relative to the planar coil antenna 10 and overlaps a part of the planar coil antenna 10 in the X-direction. Other configurations are the same as those of the third embodiment. As described above, an x-direction center position of the high-frequency antenna 20 and an X-direction center of the planar coil antenna 10 need not be aligned with each other in the Y-direction. The antenna device 4B according to the present embodiment can also have the same effects as those of the third embodiment.

It is apparent that the present invention is not limited to the above embodiments, but may be modified and changed without departing from the scope and spirit of the invention.

For example, although the planar coil antenna 10 is constituted of a spiral pattern with several turns in the above respective embodiments, the loop pattern may be one in which the number of turns is less than one. That is, the planar coil antenna 10 only needs to be a loop-shaped or a spiral-shaped planar coil pattern. In a case of the loop pattern in which the number of turns is less than one, the number of turns is preferably ¾ or more, and an inside of a circle defined by a diameter of the loop can be regarded as the inner diameter portion of the planar coil antenna 10.

Further, although the smartphone is taken as an example of the mobile wireless terminal in which the antenna device is incorporated, the mobile wireless device is not especially limited in type, but may be a tablet terminal, a note PC, a wrist-watch type wearable terminal, or the like.

What is claimed is:

1. An antenna device comprising:
a planar coil antenna;
a high-frequency antenna that overlaps a part of the planar coil antenna in a plan view; and
a magnetic sheet that overlaps another part of the planar coil antenna without overlapping the high-frequency antenna in a plan view.

2. The antenna device as claimed in claim 1, wherein the high-frequency antenna does not cover a coil axis of the planar coil antenna.

3. The antenna device as claimed in claim 1, wherein an area of a region where the high-frequency antenna overlaps an inner diameter portion of the planar coil antenna is less than 62.5% of a total area of the inner diameter portion of the planar coil antenna.

4. The antenna device as claimed in claim 3, wherein the area of a region where the high-frequency antenna overlaps an inner diameter portion of the planar coil antenna is equal to or more than 12.5% and equal to or less than 50% of the total area of the inner diameter portion of the planar coil antenna.

5. The antenna device as claimed in claim 1, wherein the planar coil antenna has a loop-shaped or spiral-shaped coil pattern, and the high-frequency antenna covers a part of the coil pattern and a part of an inner diameter portion surrounded by the coil pattern.

6. The antenna device as claimed in claim 1, wherein the planar coil antenna, high-frequency antenna, and magnetic sheet are housed inside a housing of a mobile wireless device, and a part of the housing that covers at least the planar coil antenna and high-frequency antenna is made of resin.

7. The antenna device as claimed in claim 1, wherein the planar coil antenna and magnetic sheet are housed inside a housing of a mobile wireless device, and the high-frequency antenna constitutes a part of the housing.

8. An antenna device comprising:
a planar coil antenna having a loop-shaped or spiral-shaped coil pattern; and
a planar conductor overlaps a part of the coil pattern and an inner diameter portion surrounded by the coil pattern in a plan view,
wherein an area of a region where the planar conductor overlaps the inner diameter portion is less than 62.5% of a total area of the inner diameter portion.

9. The antenna device as claimed in claim 8, wherein the area of the region where the planar conductor overlaps the inner diameter portion is equal to or less than 50% of the total area of the inner diameter portion.

10. The antenna device as claimed in claim 9, wherein the area of the region where the planar conductor overlaps the inner diameter portion is equal to or more than 12.5% and equal to or less than 50%.

11. The antenna device as claimed in claim 8, wherein the planar conductor does not cover a coil axis of the planar coil antenna.

12. The antenna device as claimed in claim 8, wherein
the planar coil antenna is disposed parallel to a first direction and a second direction perpendicular to the first direction,
the planar conductor extends from one end portion toward the other end portion of the planar coil antenna in the first direction so as to cover the one end portion of the planar coil antenna without covering the other end portion of the planar coil antenna, and
an edge of the planar conductor extends in the second direction to pass across the coil pattern.

13. The antenna device as claimed in claim 8, wherein the planar coil antenna is housed inside a housing of a mobile wireless device, and the planar conductor constitutes a part of the housing.

14. The antenna device as claimed in claim 8, wherein the planar conductor is a high-frequency antenna.

15. An antenna device comprising:
a coil pattern formed on a substrate, the coil pattern having at least first and second regions;
a first planar conductor substantially parallel to the substrate, the first planar conductor covering the first region without covering the second region; and
a RF circuit supplying a RF signal to the first planar conductor.

16. The antenna device as claimed in claim 15, further comprising a second planar conductor substantially parallel to the substrate, the second planar conductor covering the second region without covering the first region.

17. The antenna device as claimed in claim 16, wherein the coil pattern further has a third region located between the first and second regions, the third region is free from being covered with the first and second planar conductors.

18. The antenna device as claimed in claim 16, wherein the substrate is arranged between the first and second planar conductors.

19. The antenna device as claimed in claim 16, further comprising a magnetic member covering the second region without covering the first region,
wherein the substrate is arranged between the second planar conductor and the magnetic member.

20. The antenna device as claimed in claim 19, wherein the magnetic member is attached to the substrate, and has a portion that is not overlapped with the substrate.
